(19) United States
(12) Patent Application Publication
(10) Pub. No.: US 2008/0089340 A1
(43) Pub. Date: Apr. 17, 2008

(54) SYSTEM AND METHOD FOR TESTING TRANSMISSION SPEEDS OF NETWORK INTERFACE CARDS IN A COMPUTER

(75) Inventor: MO-YING TONG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,015

(22) Filed: Dec. 22, 2006

(30) Foreign Application Priority Data
Oct. 13, 2006 (CN) 200610063078.3

(51) Int. Cl. H04L 12/56

(52) U.S. Cl. 370/392; 370/401

(57) ABSTRACT

A method for testing transmission speeds of network interface cards (NICs) in a computer (1), the computer being installed with a first NIC (11) and a second NIC (12), the computer being further connected to a virtual NIC (21), the method includes the steps of: configuring/setting an internet protocol (IP) address of the first NIC and an IP address of the second NIC, and configuring an IP address of the virtual NIC and a message authentication code (MAC) address of the virtual NIC; setting the second NIC to a promiscuous mode; setting an NIC transmission speed benchmark; obtaining the IP address and the MAC address of the virtual NIC, and sending a predefined amount of successive data packets of a predetermined size to the virtual NIC via the first NIC according to the IP address and the MAC address of the virtual NIC; capturing the predefined amount of successive data packets of the predetermined size via the second NIC; clocking a time for capturing the predefined amount of successive data packets of the predetermined size via the second NIC; computing a transmission speed of the first NIC and the second NIC according to the time for capturing the predefined amount of successive data packets of the predetermined size; and comparing the transmission speed to the NIC transmission speed benchmark to determine whether the first NIC and the second NIC pass the test. A related system is also provided.

### BACKGROUND OF THE INVENTION

1. Field of the Invention

The present invention is related to systems and methods for testing peripheral devices of computers, and more particularly, to a system and method for testing transmission speeds of network interface cards in a computer.

2. Description of Related Art

Each NIC has a unique 48-bit serial number called a message authentication code (MAC) address. The MAC address is written to read only memory (ROM) carried on the NIC. Each computer on the computer network must have an NIC that has a unique MAC address. Any two NICs, regardless of place of manufacture, should not have a matching MAC address. The NICs are expansion cards that attaches to a data bus of a computer, however, newer computers usually have a network interface pre-built into motherboards.

An NIC typically has a twisted pair, bayonet nut connector (BNC), or attachment unit interface (AUI) socket where a network cable is connected, and a couple of light-emitting diodes (LEDs) indicating whether the network is active, and whether or not there is data transmitted through it. The NICs are typically available in 10/100/1000 Mbits/s (Mbps). This means they can support a transfer rate of 10 or 100 or 1000 Megabits per second.

The NIC is an absolutely necessary basic device connected to a network in a computer. Once the NIC malfunctions, the computer cannot transmit data with the network. Thus, it is necessary to test a transmission speed of the NIC before encasement. A conventional method in testing an NIC is by using a client/server (C/S) combination. That is to say, connecting a server with a client via an NIC of the server and an NIC of client, and testing a transmission speed when data is sent between the server and the client. However, the method previously described has disadvantages. For example, the method requires at least two computers (the server and the client) to conduct the testing, using two computers is an efficient use of resources, such as costs and space.

Accordingly, what is needed is a system and method for testing the transmission speed of NICs in a computer.

### SUMMARY OF THE INVENTION

One preferred embodiment provides a system for testing transmission speeds of network interface cards (NICs) in a computer. The computer being installed with a first NIC and a second NIC, and the computer being further connected to a virtual NIC. The system includes an NIC configuration module, a benchmark setting module, a data packet sending module, a data packet capturing module, a timer module, a computing module, and a determining module. The NIC configuration module is used for configuring/setting an internet protocol (IP) address of the first NIC and an IP address of the second NIC, configuring an IP address of the virtual NIC and a message authentication code (MAC) address of the virtual NIC, and setting the second NIC in a promiscuous mode. The benchmark setting module is used for setting an NIC transmission speed benchmark. The data packet sending module is used for obtaining the IP address and the MAC address of the virtual NIC, and sending a predefined amount of successive data packets of a predetermined size to the virtual NIC via the first NIC according to the IP address and the MAC address of the virtual NIC. The data packet capturing module is used for capturing the predefined amount of successive data packets of the predetermined size via the second NIC. The timer module is used for clocking a time for capturing the predefined amount of successive data packets of the predetermined size via the second NIC. The computing module is used for computing a transmission speed of the first NIC and the second NIC according to the time for capturing the predefined amount of successive data packets of the predetermined size. The determining module is used for comparing the transmission speed to the NIC transmission speed benchmark to determine whether the first NIC and the second NIC pass the test.

Another preferred embodiment provides a method for testing transmission speeds of network interface cards (NICs) in a computer. The computer is installed with a first NIC and a second NIC, and is further connected to a virtual NIC. The method includes the steps of: configuring/setting an internet protocol (IP) address of the first NIC and an IP address of the second NIC, and configuring an IP address of the virtual NIC and a message authentication code (MAC) address of the virtual NIC; setting the second NIC to a promiscuous mode; setting an NIC transmission speed benchmark; obtaining the IP address and the MAC address of the virtual NIC, and sending a predefined amount of successive data packets of a predetermined size to the virtual NIC via the first NIC according to the IP address and the MAC address of the virtual NIC; capturing the predefined amount of successive data packets of the predetermined size via the second NIC; clocking a time for capturing the predefined amount of successive data packets of the predetermined size via the second NIC; computing a transmission speed of the first NIC and the second NIC according to the time for capturing the predefined amount of successive data packets of the predetermined size; and comparing the transmission speed to the NIC transmission speed benchmark to determine whether the first NIC and the second NIC pass the test.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of a system for testing transmission speeds of network interface cards in a computer in accordance with one preferred embodiment;

FIG. 2 is a schematic diagram of function modules of the computer in FIG. 1; and

FIG. 3 is a flowchart of a method for testing transmission speeds of network interface cards in a computer in accordance with one preferred embodiment.

### DETAILED DESCRIPTION OF THE INVENTION

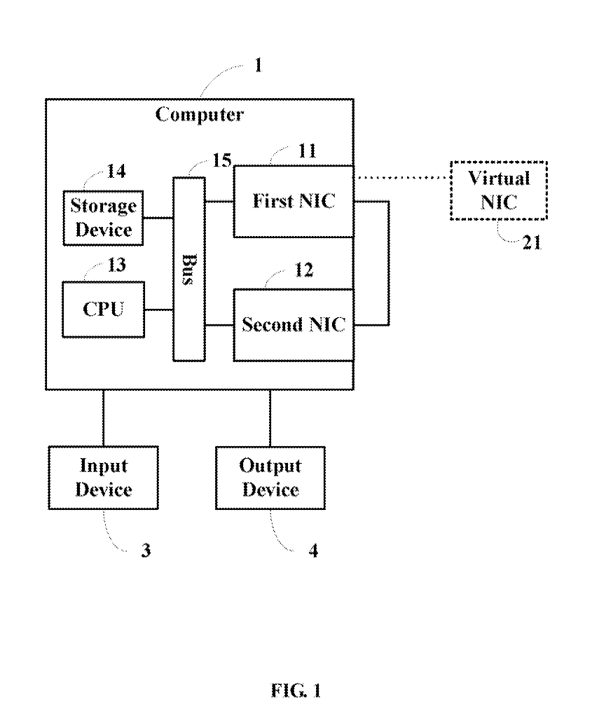

FIG. 1 is a schematic diagram of a system for testing transmission speeds of network interface cards in a computer 1 in accordance with one preferred embodiment. The computer 1 is connected with an input device 3 and an output device 4. The computer 1 may be an IBM architecture personal computer (PC), or any other type of computer. Typically, the computer 1 may include a first network interface card (NIC) 11, a second NIC 12, a central processing unit (CPU) 13, a storage device 14, and a bus 15. The first NIC 11, the second NIC 12, the CPU 13, and the storage device 14 are connected to the bus 15 for data transmission. The first NIC 11 is connected to the second NIC via a network cable. Wherein, the network cable can be a crossover cable. That is, one end of the network cable complies with the TIA/EIA-568-A standard, and the other end of the network cable complies with the TIA/EIA-568-B standard.

A UNIX/Linux operating system may be installed in the storage device 14 and loaded in the computer 1. The Linux operating system may be Slackware, Redhat, Suse, TurboLinux, Debian, XteamLinux, BluePoint, or Red Flag Linux. Since the kernel of the Linux operating system is a loopback adapter, data packets are transmitted via a network layer directly between two NICs in a same computer, but not via a data link layer and/or physical layer. Thus, the computer 1 may also be configured with a virtual NIC 21 via the first NIC 11. The data packets can be transmitted to the virtual NIC 21 via the first NIC 11 and then forwarded and captured by the second NIC 12.

The input device 3, which may be a keyboard and/or a mouse, is used for inputting information such as an NIC transmission speed benchmark into computer 1. The output device 4, which may be, for example, a display, is used for outputting test result information. The storage device 14, which may be a hard disk and/or a memory, is used for loading the Unix/Linux operating system, and for storing the data packets captured by the second NIC 12.

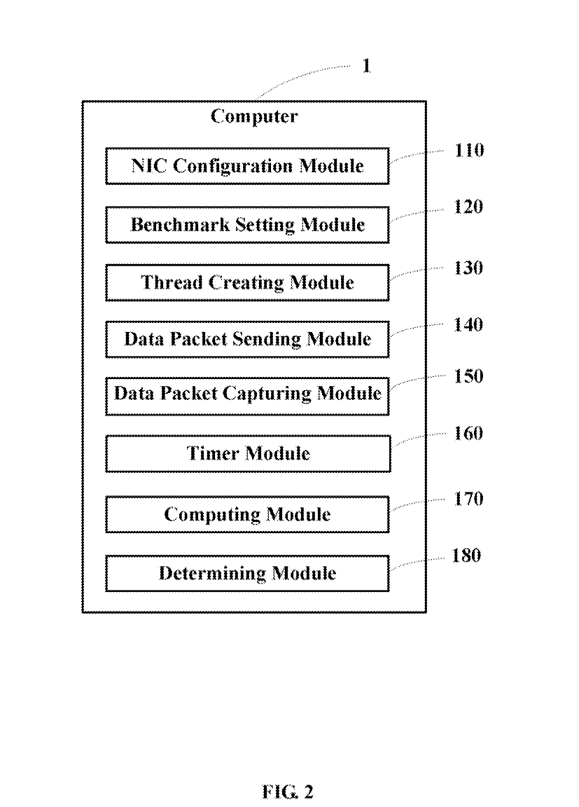

FIG. 2 is a schematic diagram of function modules of the computer 1. The computer 1 mainly includes an NIC configuration module 110, a benchmark setting module 120, a thread creating module 130, a data packet sending module 140, a data packet capturing module 150, a timer module 160, a computing module 170, and a determining module 180.

The NIC configuration module 110 is used for configuring/setting an internet protocol (IP) address of the first NIC 11 and an IP address of the second NIC 12, and also for configuring an IP address of the virtual NIC 21 and a message authentication code (MAC) address of the virtual NIC 21. In the preferred embodiment, the IP addresses of the first NIC 11, the second NIC 12, and the virtual NIC 21 are configured in the same net segment. For example, “192.168.0.1” is for the IP address of the first NIC 11, “192.168.0.2” is for the IP address of the second NIC 12, and “192.168.0.254” is for the IP address of the virtual NIC 21. The first NIC 11 and the second NIC 12 are actual physical NICs in the computer 1, and each NICs has a fixed MAC address. In the preferred embodiment, the MAC address of the virtual NIC 21 is configured to be different from the MAC address of the first NIC 11 and the MAC address of the second NIC 12.

The NIC configuration module 110 is further used for setting the second NIC 12 to a promiscuous mode. Generally speaking, an NIC has four different modes: broadcast mode, multicast mode, direct mode, and promiscuous mode. In the promiscuous mode, the second NIC 12 passes all traffic it receives to the CPU 13 rather than just data packets addressed to it.

The benchmark setting module 120 is used for setting an NIC transmission speed benchmark according to testing need. The NIC transmission speed benchmark is a standardize reference for evaluating and testing a transmission speed of the first NIC 11 and the second NIC 12. In the preferred embodiment, the NIC transmission speed benchmark is set as 98 MB/S by the benchmark setting module 120.

The thread creating module 130 is used for creating a first thread and a second thread. The first thread is used for allocating time slices of the CPU 13 to the data packet sending module 150, while the second thread is used for allocating time slices of the CPU 13 to the data packet capturing module 140 and the timer module 160. In another preferred embodiment, the first thread and the second thread can be replaced by a main process. That is, the main process allocates time slices of the CPU 13 to the data packet sending module 140, the data packet capturing module 150, and the timer module 160.

The data packet sending module 140 is used for obtaining the IP address and the MAC address of the virtual NIC 21, and sending a predefined amount of successive data packets of a predetermined size to the virtual NIC 21 via the first NIC 11 according to the IP address and the MAC address of the virtual NIC 21. Usually, data packets, which are transmitted over the Ethernet in blocks, vary from 64 bytes to 1,518 bytes. In the preferred embodiment, the data packet sending module 140 sends 20,000 data packets, each of which has a predetermined size of 1,440 bytes (B).

The data packet capturing module 150 is used for capturing the predefined amount of successive data packets of the predetermined size via the second NIC 12, and for storing the captured data packets in the storage device 14.

The timer module 160 is used for clocking a time for capturing the predefined amount of successive data packets of the predetermined size via the second NIC 12. Once the data packet capturing module 150 captures a first data packet of the predefined amount of successive data packets, the timer module 160 starts timing until the data packet capturing module 150 captures a last data packet of the predefined amount of successive data packets.

The computing module 170 is used for computing a transmission speed of the first NIC 11 and the second NIC 12 according to the time for capturing the predefined amount of successive data packets of the predetermined size. For example, if the time is 0.25 second (S),

$$the transmission speed = \frac{20 \text{,} 000 \times 1 \text{,} 440 B}{0.25 S} = 115 \text{,} 200 \text{,} 000 B / S ,$$

that is

$$\frac{115 \text{,} 200 \text{,} 000}{1024 \times 1024} MB / S = 109.8633 MB / S .$$

The determining module 180 is used for comparing the transmission speed to the NIC transmission speed benchmark. Wherein, if the transmission speed surpasses the NIC transmission speed benchmark, the first NIC 11 and the second NIC 12 pass the test; if the transmission speed does not surpass the NIC transmission speed benchmark, the first NIC 11 and/or the second NIC 12 fail the test. In the example, the transmission speed (109.8633 MB/S) is greater than the NIC transmission speed benchmark (98 MB/S), which means the first NIC 11 and the second NIC pass the test.

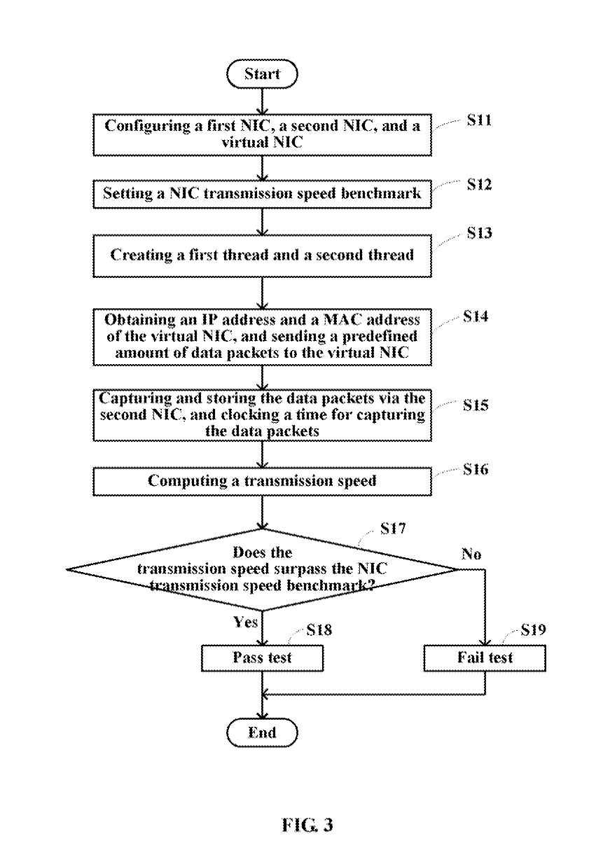

FIG. 3 is a flowchart of a method for testing transmission speeds of network interface cards in a computer in accordance with one preferred embodiment.

In step S11, The NIC configuration module 110 configures/sets an IP address of the first NIC 11, an IP address of the second NIC 12, an IP address of the virtual NIC 21, a MAC address of the virtual NIC 21, and configures the second NIC 12 to be in the promiscuous mode. In the preferred embodiment, the IP addresses of the first NIC 11, the second NIC 12, and the virtual NIC 21 are configured in the same net segment, and the MAC address of the virtual NIC 21 is configured to be different from the MAC address of the first NIC 11 and the MAC address of the second NIC 12.

In step S12, the benchmark setting module 120 sets an NIC transmission speed benchmark according to testing need. The NIC transmission speed benchmark is a standardize reference for evaluating and testing a transmission speed of the first NIC 11 and the second NIC 12. In the preferred embodiment, the NIC transmission speed benchmark is set as 98 MB/S.

In step S13, the thread creating module 130 creates a first thread and a second thread. Wherein the first thread allocates time slices of the CPU 13 for sending the data packets to the virtual NIC 21, and the second thread allocates time slices of the CPU 13 for capturing the data packets and clocking the time.

In step S14, the data packet sending module 140 obtains the IP address and the MAC address of the virtual NIC 21, and sends a predefined amount of successive data packets of a predetermined size to the virtual NIC 21 via the first NIC 11 according to the IP address of the virtual NIC 21 and the MAC address of the virtual NIC 21.

In step S15, the data packet capturing module 150 captures the predefined amount of successive data packets of the predetermined size via the second NIC 12, and stores the captured data packets in the storage device 14, and the timer module 160 clocks a time for capturing the predefined amount of successive data packets of the predetermined size via the second NIC 12.

In step S16, the computing module 170 computes a transmission speed of the first NIC 11 and the second NIC 12 according to the time for capturing the predefined amount of successive data packets of the predetermined size.

In step S17, the determining module 180 determines whether the transmission speed surpasses the NIC transmission speed benchmark.

In step S18, if the transmission speed surpasses the NIC transmission speed benchmark, the first NIC 11 and the second NIC 12 pass the test.

In step S19, if the transmission speed does not surpass the NIC transmission speed benchmark, the first NIC 11 and/or the second NIC 12 fail the test.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for testing transmission speeds of network interface cards (NICs) in a computer, the computer being installed with a first NIC and a second NIC, and the computer being connected to a virtual NIC, the system comprising:
an NIC configuration module for configuring/setting an internet protocol (IP) address of the first NIC and an IP address of the second NIC, configuring an IP address of the virtual NIC and a message authentication code (MAC) address of the virtual NIC, and setting the second NIC to a promiscuous mode;
a benchmark setting module for setting an NIC transmission speed benchmark;
a data packet sending module for obtaining the IP address and the MAC address of the virtual NIC, and sending a predefined amount of successive data packets of a predetermined size to the virtual NIC via the first NIC according to the IP address and the MAC address of the virtual NIC;
a data packet capturing module for capturing the predefined amount of successive data packets of the predetermined size via the second NIC;
a timer module for clocking a time for capturing the predefined amount of successive data packets of the predetermined size via the second NIC;
a computing module for computing a transmission speed of the first NIC and the second NIC according to the time for capturing the predefined amount of successive data packets of the predetermined size ; and
a determining module for comparing the transmission speed to the NIC transmission speed benchmark to determine whether the first NIC and the second NIC pass the test.

2. The system according to claim 1, further comprising: a thread creating module for creating a first thread and a second thread.

3. The system according to claim 2, wherein the first thread is used for allocating time slices of a CPU of the computer to the data packet sending module, and the second thread is used for allocating time slices of the CPU to the data packet capturing module and the timer module.

4. The system according to claim 1, wherein the IP addresses of the first NIC, the second NIC, and the virtual NIC are configured in the same net segment; and the MAC address of the virtual NIC is configured to be different from the MAC address of the first NIC and the MAC address of the second NIC.

5. The system according to claim 1, wherein the first NIC and the second NIC pass the test, if the transmission speed surpasses the NIC transmission speed benchmark.

6. The system according to claim 1, wherein the first NIC and/or the second NIC fail the test, if the transmission speed does not surpass the NIC transmission speed benchmark.

7. A method for testing transmission speeds of network interface cards (NICs) in a computer, the computer is installed with a first NIC and a second NIC, and is connected to a virtual NIC, the method comprising the steps of:
configuring/setting an internet protocol (IP) address of the first NIC and an IP address of the second NIC, and configuring an IP address of the virtual NIC and a message authentication code (MAC) address of the virtual NIC;
setting the second NIC to a promiscuous mode;
setting an NIC transmission speed benchmark;
obtaining the IP address and the MAC address of the virtual NIC, and sending a predefined amount of successive data packets of a predetermined size to the virtual NIC via the first NIC according to the IP address and the MAC address of the virtual NIC;
capturing the predefined amount of successive data packets of the predetermined size via the second NIC;
clocking a time for capturing the predefined amount of successive data packets of the predetermined size via the second NIC;
computing a transmission speed of the first NIC and the second NIC according to the time for capturing the predefined amount of successive data packets of the predetermined size; and
comparing the transmission speed to the NIC transmission speed benchmark to determine whether the first NIC and the second NIC pass the test.

8. The method according to claim 7, further comprising the steps of: creating a first thread and a second thread.

9. The method according to claim 8, wherein the first thread allocates time slices of a CPU of the computer for sending the data packets to the virtual NIC, and the second thread allocates time slices of the CPU for capturing the data packets and clocking the time.

10. The method according to claim 7, wherein the determining result comprises:
if the transmission speed surpasses the NIC transmission speed benchmark, the first NIC and the second NIC pass the test; and
if the transmission speed does not surpass the NIC transmission speed benchmark, the first NIC and/or the second NIC fail the test.

11. The method according to claim 7, wherein the IP addresses of the first NIC, the second NIC, and the virtual NIC are configured in the same net segment; and the MAC address of the virtual NIC is configured to be different from the MAC address of the first NIC and the MAC address of the second NIC.
